(19) United States
(12) Patent Application Publication
(10) Pub. No.: US 2015/0004298 A1
(43) Pub. Date: Jan. 1, 2015

(54) LOW LEVEL BLEND OF MONATIN AND REBAUDIOSIDE A

(71) Applicant: CARGILL, INCORPORATED, Wayzata, MN (US)

(72) Inventor: Melanie Jean Goulson, Dayton, MN (US)

(73) Assignee: Cargill, Incorporated, Wayzata, MN (US)

(21) Appl. No.: 14/367,524

(22) PCT Filed: Dec. 20, 2012
(86) PCT No.: PCT/US12/71033

§ 371 Date: Jun. 20, 2014

Related U.S. Application Data
(60) Provisional application No. 61/578,033, filed on Dec. 20, 2011.

(51) Int. Cl. A23L 1/221; A23L 2/60

(52) U.S. Cl. CPC A23L 1/221; A23L 2/60; A23V 2002/00
USPC 426/548

(57) ABSTRACT

An edible consumable composition comprises rebaudioside A in an amount less than or equal to 30 ppm and monatin in an amount of less than or equal to 4 ppm. This combination of rebaudioside A and monatin has been found to provide food and beverages with excellent sweetness characteristics, and additionally provide excellent taste profiles. Methods of making edible consumable compositions and formulating reduced sugar compositions are also described.

### RELATED APPLICATIONS

The present application claims the benefit of U.S. Provisional Patent Application No. 61/578,033, filed Dec. 20, 2011, the disclosure of which is incorporated by reference herein in its entirety.

### FIELD OF THE INVENTION

The present invention relates to edible consumable compositions comprising monatin and rebaudioside A. More specifically, the present invention relates to food and beverage compositions comprising low level blends of monatin and rebaudioside A.

### BACKGROUND OF THE INVENTION

The use of high intensity sweeteners allow for the formulation of sweetened beverages with zero or significantly fewer calories than conventional beverages, an important health and wellness feature as many countries are attempting to address weight related public health concerns. In particular a naturally occurring high potency sweetener with a pleasing, sugar-like taste profile is desirable.

Historically, sugar replacement, even at 10-15%, using high potency sweeteners (HPS) results in foods and beverages with different sensory characteristics. In general, HPS result in a different sweetness onset or lingering sweetness in comparison to sugars. In addition, this change in sweetness profile often causes an imbalance in the flavor profile, creating a diet-like or “artificial” perception. Blending of high potency sweeteners can help manage these sensory off notes, but still provides a diet-like profile (i.e. acesulfame K/aspartame).

### SUMMARY OF THE INVENTION

An edible consumable composition is provided that comprises rebaudioside A in an amount less than or equal to 30 ppm and monatin in an amount of less than or equal to 4 ppm. This combination of rebaudioside A and monatin has been found to provide food and beverages with excellent sweetness characteristics, and additionally provide excellent taste profiles. The addition of rebaudioside A and monatin at these levels advantageously has the effect of making reduced sugar compositions taste like conventional, non-reduced sugar compositions without introducing bitterness or other undesirable taste effects normally associated with non-sugar sweeteners by consumers.

In an embodiment of the present invention, full sugar formulations of food and beverage products may be reformulated to reduce the amount of sugar present by from about 5 to about 45% by weight and additionally to incorporate rebaudioside A in an amount less than or equal to 30 ppm; and monatin in an amount of less than or equal to 4 ppm. It has surprisingly been discovered that full sugar edible consumable compositions can be reformulated to provide a reduced calorie product without discernable adverse sweetness and flavor impact. In a preferred embodiment of the invention, a 25% reduction in sugar and calories can be made by reformulation as indicated herein without change in sensory experience.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated.

As used herein, the term “about” encompasses the range of experimental error that occurs in any measurement.

As used herein, an “edible consumable” composition or product includes food and beverages that are perceived to have a sweet flavor component by consumers.

Rebaudioside A is provided in an amount less than or equal to 30 ppm. In a preferred embodiment, rebaudioside A is provided in an amount from about 15 to about 30 ppm. In another preferred embodiment, rebaudioside A is provided in an amount from about 20 to about 30 ppm. In a particularly preferred embodiment, rebaudioside A is provided in an amount from about 25 to about 30 ppm. The rebaudioside A can be provided by rebaudioside A compositions of varying purity. For example, rebaudioside A compositions can comprise about 30%, 40%, 50%, 80%, 90%, 95%, or 97% or greater rebaudioside A. It is understood that if the rebaudioside A composition is less pure, more rebaudioside A source composition will be incorporated into the edible consumable composition to provide the desired amounts of rebaudioside A on ppm basis.

Rebaudioside A is a glycoside found in the leaves and stems of the stevia plant. Various methods of extraction of rebaudioside A from components of the stevia plant are known, and further methods of purification of rebaudioside A from crude rebaudioside A containing stevia extracts are additionally known.

Monatin is provided in an amount less than or equal to 4 ppm. In a preferred embodiment, monatin is provided in an amount from about 0.2 to about 4 ppm. In another preferred embodiment, monatin is provided in an amount from about 1 to about 4 ppm. In a preferred embodiment, monatin is provided in an amount from about 2 to about 4 ppm. In a particularly preferred embodiment, monatin is provided in an amount from about 3 to about 4 ppm.

While each of the possible combinations of the above mentioned respective amounts of rebaudioside A and monatin are specifically contemplated, the combination of rebaudioside A in the amount from about 25 to about 30 ppm with monatin in the amount from about 3 to about 4 ppm is particularly preferred, because this combination affords superior sweetness properties while at the same time minimizing any possible adverse flavor impact in the ultimate edible consumable composition.

As used herein, unless otherwise indicated, the term “monatin” is used to refer to compositions including any combination of the four stereoisomers of monatin (or any of the salts thereof), including a single isomeric form. As used herein, unless otherwise stated, the term “monatin” is independent of the method by which the monatin was made, and thus encompasses monatin that was, for example, synthesized in whole or in part by biosynthetic pathway(s), purely synthetic means, or isolated from a natural source.

Monatin (2-hydroxy-2-(indol-3-ylmethyl)-4-aminoglutaric acid) is a naturally occurring, high intensity or high potency sweetener that was originally isolated from the plant Sclerochiton ilicifolius, found in the Transvaal Region of South Africa. Monatin has the chemical structure:

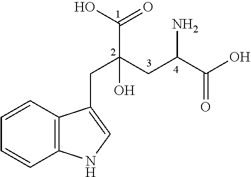 [SMILES: NC(CC(O)(Cc1c[nH]c2ccccc12)C(=O)O)C(=O)O]

Because of various naming conventions, monatin is also known by a number of alternative chemical names, including: 2-hydroxy-2-(indol-3-ylmethyl)-4-aminoglutaric acid; 4-amino-2-hydroxy-2-(1H-indol-3-ylmethyl)-pentanedioic acid; 4-hydroxy-4-(3-indolylmethyl)glutamic acid; and, 3-(1-amino-1,3-dicarboxy-3-hydroxy-but-4-yl)indole. Monatin has two chiral centers thus leading to four potential stereoisomeric configurations; the R,R configuration (the “R,R stereoisomer” or “R,R monatin”); the S,S configuration (the “S,S stereoisomer” or “S,S monatin”); the R,S configuration (the “R,S stereoisomer” or “R,S monatin”); and the S,R configuration (the “S,R stereoisomer” or “S,R monatin”).

Monatin has an excellent sweetness quality, and depending on a particular composition, monatin may be several hundred times sweeter than sucrose, and in some cases thousands of times sweeter than sucrose. Monatin has four stereoisomeric configurations which exhibit differing levels of sweetness. The S,S stereoisomer of monatin is about 50-200 times sweeter than sucrose by weight. The R,R stereoisomer of monatin is about 2000-2400 times sweeter than sucrose by weight. Depending on the methods of manufacture, purification and intended uses, a monatin composition may be a pure stereoisomer or it may be a mixture of stereoisomers.

Monatin can be isolated from the bark of the roots of the plant Sclerochiton ilicifolius. Various methods of monatin isolation from the bark of the roots of the plant Sclerochiton ilicifolius are known. In addition, monatin can also be produced via enzymatic processes, and methods of producing monatin via enzymatic processes are known.

In some embodiments, the monatin used in the compositions of the present invention consists essentially of S,S or R,R monatin. In other embodiments, the compositions contain predominantly S,S or R,R monatin. “Predominantly” means that of the monatin stereoisomers present in the composition, the monatin contains greater than 90% of a particular stereoisomer. In some embodiments, the compositions are substantially free of S,S or R,R monatin. “Substantially free” means that of the monatin stereoisomers present in the composition, the composition contains less than 2% of a particular stereoisomer. In another aspect of the present invention, a composition includes a stereoisomerically-enriched monatin mixture. “Stereoisomerically-enriched monatin mixture” means that the mixture contains more than one monatin stereoisomer and at least 60% of the monatin stereoisomers in the mixture is a particular stereoisomer, such as R,R, S,S, S,R or R,S. In other embodiments, the mixture contains greater than about 65%, 70%, 75%, 80%, 85%, 90%, 95%, 98% or 99% of a particular monatin stereoisomer. In another embodiment, a composition comprises an stereoisomerically-enriched R,R or S,S monatin. “Stereoisomerically-enriched” R,R monatin means that the monatin comprises at least 60% R,R monatin. “Stereoisomerically-enriched” S,S monatin means that the monatin comprises at least 60% S,S monatin. In other embodiments, “stereoisomerically-enriched” monatin comprises greater than about 65%, 70%, 75%, 80%, 85%, 90%, 95%, 98% or 99% of R,R or S,S monatin.

Monatin may be provided in its salt form, such as the ammonium salt, sodium salt, potassium salt, lithium salt, calcium salt and magnesium salt. See, e.g. US Patent Publication No. 2011/0189368. The edible consumable composition of the present invention may optionally comprise any other artificial sweetener or flavorant compositions, or sugars.

In an embodiment, the edible consumable composition comprises as sweetness providing components only endogenous sweetening materials, added sugars and rebaudioside A and monatin as described above, and is otherwise free of non-endogenous non-sugar sweetening materials. In this embodiment, the resulting product contains a minimal content of “non-natural” sweeteners, while at the same time providing a desired taste profile.

In another embodiment, the edible consumable composition comprises as sweetness providing components only endogenous sweetening materials and rebaudioside A and monatin as described above, and is otherwise free of non-endogenous sweetening materials. In this embodiment, the resulting product contains minimum content of all sweeteners, and additionally a minimal content of “non-natural” sweeteners, while at the same time providing a desired taste profile.

As used herein, “beverage composition” refers to a composition that is drinkable as is (i.e., does not need to be diluted, or is “ready-to-drink”) or a liquid concentrate, dry powder, or syrup that can be diluted or mixed with additional liquid to form a drinkable beverage. Beverage compositions herein include carbonated and non-carbonated soft drinks, coffee beverages, tea beverages, dairy beverages, liquid concentrates, flavored waters, enhanced waters, fruit juice and fruit juice-flavored drinks, sport drinks, and alcohol products.

It should be understood that beverages and other beverage products in accordance with this disclosure may have any of numerous different specific formulations or constitutions. The formulation of a beverage product in accordance with this disclosure can vary to a certain extent, depending upon such factors as the product's intended market segment, its desired nutritional characteristics, flavor profile and the like. For example, it will generally be an option to add further ingredients to the formulation of a particular beverage embodiment, including any of the beverage formulations described below. Additional (i.e., more and/or other) sweeteners may be added, flavorings, electrolytes, vitamins, fruit juices or other fruit products, tastants, masking agents and the like, flavor enhancers, and/or carbonation typically can be added to any such formulations to vary the taste, mouthfeel, nutritional characteristics, etc. In general, a beverage in accordance with this disclosure typically comprises at least water, sweetener, acidulant and flavoring.

Exemplary flavorings which may be suitable for at least certain formulations in accordance with this disclosure include cola flavoring, citrus flavoring, root beer flavoring, spice flavorings and others. Carbonation in the form of carbon dioxide may be added for effervescence. Natural and synthetic preservatives can be added if desired, depending upon the other ingredients, production technique, desired shelf life, etc. Optionally, caffeine can be added. Certain exemplary embodiments of the beverages disclosed here are cola-flavored carbonated beverages, characteristically containing carbonated water, sweetener, kola nut extract and/or other cola flavoring, caramel coloring, and optionally other ingredients. Additional and alternative suitable ingredients will be recognized by those skilled in the art given the benefit of this disclosure.

Some embodiments of the invention may be considered still beverages, i.e., beverages which are not carbonated. Common examples include coffee beverages, tea beverages, dairy beverages (including kefir, liquid (drinkable) yogurt and flavored milk), flavored waters, enhanced waters, non-carbonated soft drinks, fruit juice and fruit juice-flavored drinks (including orange juice, grape juice, and tomato juice), sport drinks, instant soft drinks and flavored and/or fortified water beverages (e.g., calcium-fortified monatin-containing sports drinks and energy drinks), meal replacement beverages and alcohol products other than beer and champagnes.

In other embodiments the beverage contains dissolved carbon dioxide (CO₂) in amounts sufficient to provide effervescence. Common examples include carbonated soft drinks, beer and champagnes. Such carbonated beverages typically have carbon dioxide concentrations of about 1.6 volumes CO2 per volume of beverage to about 4.2 volumes CO2 per volume of beverage. Carbon dioxide is typically introduced into a beverage by either fermentation (as in the case of beer and champagnes) or dissolving the carbon dioxide into the beverage under pressure (as in the case of carbonated beverages). Specific methods of beverage carbonation are well known to those skilled in the art.

In carbonated beverages, the process of carbonation results in a removal or displacement of dissolved oxygen from the beverage. In some embodiments, the dissolved oxygen levels may be reduced or controlled for stability purposes, as disclosed in WO 2010/138513.

In embodiments of the present invention, the beverage composition can be a dry beverage mix (e.g., flavored milk powder, citrus (e.g. lemonade), hot chocolate, coffee beverages, instant cappuccino, and tea).

As used herein, “food composition” refers to all other edible compositions that are not beverages. Preferably such food compositions are provided in a gel or solid form. Examples of gel based foods include gel-based dessert systems, such as dairy and non-dairy puddings, custards, and yogurts.

Examples of solid food compositions comprise baked goods, sugar-free and reduced sugar nutrition bars, popsicles, breakfast cereal, candy, chews, confections, jam, jelly, fruit products, and fruit preparations.

In an embodiment, the rebaudioside A and monatin components are provided throughout the food product. In another embodiment, the rebaudioside A and monatin components are provided in one or more portions of the food product that are distinguishable from one or more other portions of the food product. For example, the rebaudioside A and monatin components may be provided in a specific layer of a multi-layered food product, or on the surface of the food product. In an embodiment, the rebaudioside A and monatin components are provided only as a surface coating (such as a glaze) or in a sweetness particulate (such as sprinkles). In embodiments wherein the rebaudioside A and monatin components are provided in a portion of the food product that is distinguishable from one or more other portions of the food product, the relative amount of rebaudioside A or monatin (i.e. ppm) is determined on the basis of the weight contribution of that portion only.

In some embodiments, edible consumable compositions may include other ingredients.

In some embodiments, edible consumable compositions containing monatin and rebaudioside A may comprise other stability enhancing features, such as, for example, antioxidants. Reference is made to PCT Publication Number WO 2010/138513, titled “SHELF STABLE MONATIN SWEETENED BEVERAGE”.

Edible consumable compositions according to the present invention may be made by addition of monatin and rebaudioside A to additional ingredients at a time and manner appropriate for conventional addition of sweeteners to the composition.

In an embodiment of the present invention, monatin and rebaudioside A may be provided in edible consumable compositions in the amounts discussed herein in order to provide compositions having a reduced amount of added sugar that taste like the corresponding full-sugar compositions.

In another embodiment, monatin and rebaudioside A may be provided in edible consumable compositions in the amounts discussed herein in order to provide compositions having no added sugar (i.e. no non-endogenous sugar) that taste like the corresponding full-sugar compositions.

In another embodiment, known full sugar formulations of food and beverage products may be reformulated to reduce the amount of sugar present by from about 5 to about 45% by weight and additionally to incorporate rebaudioside A in an amount less than or equal to 30 ppm; and monatin in an amount of less than or equal to 4 ppm. The amount of rebaudioside A in an amount less than or equal to 30 ppm and monatin in an amount of less than or equal to 4 ppm to be incorporated in the formulation is determined to achieve a desired taste and flavor profile approximating the taste and flavor properties of the full sugar formulation. The thus prepared formulation may be communicated to a manufacturer, e.g. by computer, and/or incorporated in automated manufacturing equipment or ordering processes. The formulation also may be used to prepare food or beverage products according to directions and quantities set forth in the formulation. It has surprisingly been discovered that full sugar edible consumable compositions can be reformulated to provide a reduced calorie product without discernable adverse sweetness and flavor impact. In an embodiment of the invention, a reduction of from about 10 to about 35% in sugar can be made by reformulation as indicated herein without change in sensory experience. In a preferred embodiment of the invention, a reduction of from about 20 to about 30% in sugar can be made by reformulation as indicated herein without change in sensory experience.

An edible consumable composition is prepared by mixing ingredients of an edible consumable composition including rebaudioside A in an amount less than or equal to 30 ppm and monatin in an amount of less than or equal to 4 ppm.

### EXAMPLES

Representative embodiments of the present invention will now be described with reference to the following examples that illustrate the principles and practice of the present invention.

### Example 1

The objective of this study was to assess the taste of 25% reduced sugar cola containing very low levels of R,R-monatin and RA95 as taste modifiers compared to a full-calorie version of the cola. RA95 refers to a high purity rebaudioside A (≧95%) composition.

25% Reduced sugar colas with and without taste modifiers and full-calorie colas were prepared using the following formulas and procedure:

| | % (w/w) | | | | |
|---|---|---|---|---|---|
| | | | | Sample 4 | |
| | | | Sample 3 | 25% | |
| | | | 25% | Reduced | Sample 5 |
| | | | Reduced | Sugar with | 25% |
| | | Sample 2 | Sugar with | 4 ppm | Reduced |
| | | 25% | 30 ppm RA95 | Monatin | Sugar With |
| | Sample 1 | Reduced | Taste | Taste | Both Taste |
| Ingredients | Full Calorie | Sugar | Modifier | Modifier | Modifiers |
| Water | 85.935 | 89.5350 | 89.5320 | 89.5346 | 89.5316 |
| Isoclear HFCS 55 | 13.800 | 10.2000 | 10.2000 | 10.2000 | 10.2000 |
| (Cargill) | | | | | |
| RA95 | 0.000 | 0.0000 | 0.0030 | 0.0000 | 0.0030 |
| (Cargill) | | | | | |
| R, R-Monatin | 0.000 | 0.0000 | 0.0000 | 0.0004 | 0.0004 |
| (Cargill) | | | | | |
| Natural Cola Flavor | 0.250 | 0.2500 | 0.2500 | 0.2500 | 0.2500 |
| WONF #0014820 | | | | | |
| (Cargill) | | | | | |
| Cola Acid #0014785 | 0.015 | 0.0150 | 0.0150 | 0.0150 | 0.0150 |
| (Cargill) | | | | | |
| pH | 2.85 | 2.85 | 2.85 | 2.85 | 2.85 |
| TOTALS | 100.0000 | 100.0000 | 100.0000 | 100.0000 | 100.0000 |

One liter samples of each soda were prepared by weighing all the ingredients and blending them together with gentle mixing for several minutes. The samples were then carbonated using a SodaStream beverage carbonation device.

A group of six product developers with experience in developing full-calorie and reduced-calorie carbonated soft drinks determined that the 25% reduced sugar sample without taste modifiers (Sample 2), the sample with 30 ppm RA95 only (Sample 3), and the sample with 4 ppm monatin only (Sample 4) were less sweet than the full-sugar control (Sample 1). The group also concluded that the sample with both taste modifiers (Sample 5) was equivalent in sweetness and matched the full-sugar control very well with a high quality sugar-like taste.

### Example 2

New samples of the Full-Calorie Control Cola (Sample 1) and the 25% Reduced Sugar Cola with 30 ppm RA95 and 4 ppm monatin (Sample 5) were prepared by the formula and process described in Example 1. These samples were presented to a panel of average consumers to determine if they could taste a significant difference between the samples.

Triangle test methodology was used to test whether panelists could discriminate between samples. The test employed a standard triangle sample rotation plan of 6 blocks in which two identical and one different sample were presented in each block in a balanced design:

| Block Number | Sample | Sample | Sample |
|---|---|---|---|
| 1 | 1 | 5 | 1 |
| 2 | 5 | 1 | 5 |
| 3 | 1 | 1 | 5 |
| 4 | 5 | 5 | 1 |
| 5 | 1 | 5 | 5 |
| 6 | 5 | 1 | 1 |

A panel of 28 people was formed. The panelists were served 1 oz portions of soda in 2 oz soufflé cups. Samples were served at 38-40° F. Each panelist was given three samples, two of which were the same and one that was different. The panelists were instructed to taste the samples in the order that they were presented on the tray and then pick the sample that was different from the others. Panelists were also asked to comment on the difference between the samples. The number of correct responses was tallied and p-value was calculated at the 95% confidence level using Alpha One Tailed Analysis.

| | | | | One | |
|---|---|---|---|---|---|
| Test | Probability | # | | Tailed P- | |
| Type | (Pc) | Panelists | Correct | Value | Conclusion |
| Triangle | 0.33333 | 28 | 12 | 0.1911 | No Significant |
| | | | | | Difference |

In this test, 12 out of 28 panelists were able to correctly identify the different sample, and it was concluded that there is no significant difference between samples at 95% confidence level.

An experienced sensory analyst also reviewed comments from those panelists who correctly identified the different sample. The analyst determined that the comments were inconsistent and no pattern was identifiable. Thus, the panelists were not able to differentiate between the Full-Calorie Control Cola and the 25% Reduced Sugar Cola with 30 ppm RA95 and 4 ppm monatin. This surprisingly shows that addition of the monatin and rebaudioside A allowed sugar reduction without resulting in a different taste or flavor profile than the full calorie beverage.

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

What is claimed is:

1. An edible consumable composition comprising:
a) rebaudioside A in an amount less than or equal to 30 ppm; and
b) monatin or a salt thereof in an amount of less than or equal to 4 ppm.

2. The edible consumable composition of claim 1, wherein rebaudioside A is provided in an amount from about 15 to about 30 ppm, preferably from about 20 to about 30 ppm, and more preferably from about 25 to about 30 ppm.

3. The edible consumable composition of claim 1 or 2, wherein monatin is provided in an amount from about 0.2 to about 4 ppm, preferably from about 1 to about 4 ppm, more preferably from about 2 to about 4 ppm, and more preferably from about 3 to about 4 ppm.

4. The edible consumable composition of claim 1, wherein rebaudioside A is provided in the amount from about 25 to about 30 ppm, and monatin is provided in the amount from about 3 to about 4 ppm.

5. The edible consumable composition of one of claims 1-4, wherein monatin is provided in the form of a salt.

6. The edible consumable composition of one of claims 1-5, wherein the edible consumable composition comprises as sweetness providing components only endogenous sweetening materials, added sugars and rebaudioside A and monatin, and is otherwise free of non-endogenous non-sugar sweetening materials.

7. The edible consumable composition of one of claims 1-5, wherein the edible consumable composition comprises as sweetness providing components only endogenous sweetening materials and rebaudioside A and monatin, and is otherwise free of non-endogenous sweetening materials.

8. The edible consumable composition of one of claims claim 1-7, wherein the edible consumable composition is a beverage composition.

9. The edible consumable composition of claim 8 wherein the beverage composition is a carbonated beverage.

10. The edible consumable composition of claim 8 wherein the beverage composition is a still beverage.

11. The edible consumable composition of one of claims 1-7, wherein the edible consumable composition is a solid composition.

12. The edible consumable composition of one of claim 1-7, wherein the edible consumable composition is a gel composition.

13. A method of formulating an edible consumable composition comprising:
a) identifying a full sugar formulation of an edible consumable composition;
b) reducing the amount of sugar present in the identified full sugar formulation by from about 5 to about 45% by weight;
c) determining an amount of rebaudioside A in an amount less than or equal to 30 ppm and monatin in an amount of less than or equal to 4 ppm to be incorporated in the formulation to achieve a desired flavor provide approximating the flavor properties of the full sugar formulation.

14. A method of making an edible consumable composition comprising mixing ingredients of an edible consumable composition including rebaudioside A in an amount less than or equal to 30 ppm and monatin in an amount of less than or equal to 4 ppm.
